(19) United States
(12) Patent Application Publication
(10) Pub. No.: US 2011/0166960 A1
(43) Pub. Date: Jul. 7, 2011

(54) DIGITAL CONTENT RECYCLING SYSTEM

(76) Inventor: Milton Kim, Costa Mesa, CA (US)

(21) Appl. No.: 12/985,225

(22) Filed: Jan. 5, 2011

Related U.S. Application Data
(60) Provisional application No. 61/292,242, filed on Jan. 5, 2010.

(51) Int. Cl. G06Q 30/00

(52) U.S. Cl. 705/26.25; 705/26.1

(57) ABSTRACT

A computer network where artistically created digital content is distributed. An artist transmits the artistically created digital content from an artist workstation computer to a digital content recycling system computer via a computer network. The artistically created digital content is offered for sale by the artist at an initial sales price via the digital content recycling system computer. First consumer computers and secondary consumer computers are also connected to the digital content recycling system computer via the computer network. A first consumer purchases the artistically created digital content via the first consumer computer at the initial selling price. Operating under permission of the artist, the first consumer can then later sell the artistically created digital content via the digital content recycling system computer to a subsequent consumer at a reduced recycling price. In a preferred embodiment, subsequent consumers can continue to sell the artistically created digital content to other subsequent consumers at progressively lower and lower recycling prices. In a preferred embodiment, a recycling fee is collected each time the digital content is recycled. By licensing purchasers of the digital content to sell the digital content, consumers are motivated to sell the digital content in accordance with the license rather than give it away in violation of the artist's copyright.

This application claims the benefit of Provisional Application 61/292,242 filed Jan. 5, 2010, which is incorporated by reference herein. The present invention relates to distribution of artistically created digital content, and in particular, to artistically created digital content distributed via a computer network.

### BACKGROUND OF THE INVENTION

FIG. 1 illustrates the conventional digital content distribution system. Traditionally artists have been unable to distribute their creations directly to the consumers since it requires a tremendous financial support through the process. Record labels have taken the role of financial support for the artists by providing them with studio time, financing, and marketing. In return, the artists allow the record labels to control the whole process including revenue sharing. In the prior art, the consumer buys CDs, DVDs, audio books at the local record shops, book stores, or places an order by mail and/or online through the Internet. Since the creation of the artists can be presented in a digital form, it has been extremely easy to make a duplicate and distribute the content instantly to anyone who is able to access the Internet. The advance of technologies made the artists' digital content very vulnerable to copyright infringement and digital piracy. Napster is the most notorious example of mp3 file piracy. Even though the artists and record labels are protected by law, the protection of digital copyright has become the central issues to the industry. Since the advent of digital recording, many technological methods to combat piracy have been devised and deployed commercially. However prior art technological measures require certain limitations on the medium such as CDs and DVDs so that a special media player is required to play the content correctly.

What is needed is a better method for distributing digital content from artists to consumers.

### SUMMARY OF THE INVENTION

The present invention provides a computer network where artistically created digital content is distributed. An artist transmits the artistically created digital content from an artist workstation computer to a digital content recycling system computer via a computer network. The artistically created digital content is offered for sale by the artist at an initial sales price via the digital content recycling system computer. First consumer computers and secondary consumer computers are also connected to the digital content recycling system computer via the computer network. A first consumer purchases the artistically created digital content via the first consumer computer at the initial selling price. The first consumer can then later sell the artistically created digital content via the digital content recycling system computer to a subsequent consumer at a reduced recycling price. In a preferred embodiment, subsequent consumers can continue to sell the artistically created digital content to other subsequent consumers at progressively lower and lower recycling prices. In a preferred embodiment, a recycling fee is collected each time the digital content is recycled. By licensing purchasers of the digital content to sell the digital content, consumers are motivated to sell the digital content in accordance with the license rather than give it away in violation of the artist's copyright.

### BRIEF DESCRIPTION OF THE DRAWINGS

FIG. 1 illustrates a block diagram of a prior art digital content distribution system.

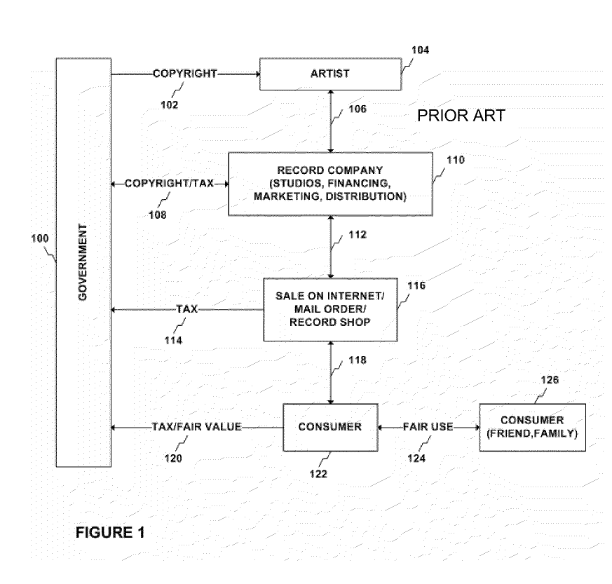

FIG. 2 illustrates a block diagram of digital content recycling system.

FIG. 3 illustrates a block diagram which shows the recycling flow of digital content under the artist's recycling consent.

FIG. 4 illustrates a block diagram which shows the flow of aggregated revenues that are generated through the recycling process of digital content.

FIG. 5 illustrates the change of sales price of a digital content in the recycling process.

FIG. 6 illustrates the aggregated revenue per digital content in the recycling process.

FIG. 7 illustrates a block diagram of digital content recycling system, artist workstation, and media player.

FIG. 8 illustrates a flow of the artist registration to digital content recycling system.

FIG. 9 illustrates a flow chart of the secure submission of figital content to digital content recycling system that was created by the artist.

FIG. 10 illustrates a flow chart of the secure transmission of digital content to the consumer's media player.

FIG. 11 illustrates a flow chart of the recycling of digital content initiated by the consumer.

FIG. 12 illustrates a flow chart of the synchronization of media player to digital content recycling system.

FIG. 13 illustrates a flow chart of the synchronization of digital content list stored in the secure processor of media player.

FIG. 14 illustrates an exemplary web page for the purchase of digital content.

FIG. 15 illustrates an exemplary web page for the selection of recycling content from a list.

FIG. 16 illustrates an exemplary web page for the purchase of original and recycling digital contents.

FIG. 17 illustrates an exemplary web page for the maintenance of media player.

FIG. 18 illustrates the digital content list and record structure stored in the memory of secure processor of the consumer's media player.

### DETAILED DESCRIPTION OF THE PREFERRED EMBODIMENTS

### 1. Direct Access to Consumers

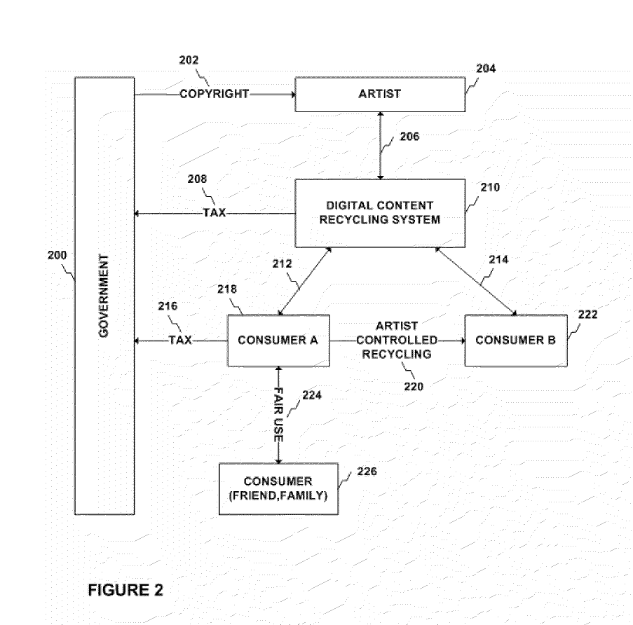

One preferred embodiment of the present invention is shown in FIG. 2. With the present invention, artists are now able to assume the role of record labels. The artists can utilize the Internet as the way of achieving direct access to the consumers. However, even if the artists are able to reach to the consumer directly, they still must take measures to protect their creations from illegal piracy.

### 2. Digital Content Recycling

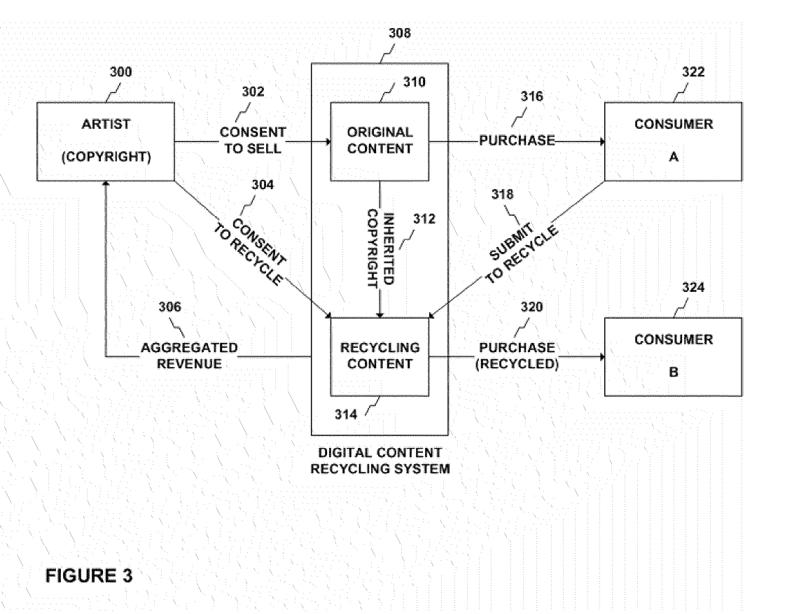

A digital content recycling indicates the purchase of digital content that was made between consumers, not between artist and consumer. FIG. 3 illustrates a preferred digital content recycling process. The artist 300 who is the copyright owner submits their creation to Digital Content Recycling System (hereinafter, the System) in a digital form. The artist gives the System the consent 302 to sell their creations to consumers. A consumer accesses the System online and then makes a purchase on digital contents 316. After a certain time called recycling-free period passed, that consumer is allowed to recycle the digital contents 318 that he/she purchased. The artist gives the consumer the consent 304 to recycle their creations at a price that the consumer chooses. Then another consumer can buy the recycled digital content 320 or the original content. It is assumed that the recycled content inherited the copyright from the original content under the consent from the artist 312. The consumer who is recycling the digital contents is subject to recycling process fee and will receive a credit after the processing fee was applied to the recycling price. The System gets the sales price from the first consumer and then collects the recycling process fees 306 from the next recycling purchases. The recycling process fee is determined by both artist and the System. Usually it is set below the recycling price. The gap between the sales and/or recycling price and the recycling processing fee is the key factor of the System. As long as the price gap exists, the consumer will have an opportunity to make “recycling sales” with the contents that he/she purchased. With this possibility, the digital content can be protected from the piracy since the consumer will not undermine the recycling values of their digital contents by committing the copyright violation. When the recycling is made, the consumer who recycles is allowed to choose to keep the digital contents or not. Obviously, the recycling process fee will apply differently. The recycling process brings three positive effects to the System: 1) it will turn the consumer into someone who is acting with proactive copyright compliance, 2) it will accelerate the distribution process and propagate widely since the price barrier goes down as the recycling continues, and 3) the recycling of a digital content must end within a finite number of recycling cycles when the recycling price is less than the recycling processing fee. Therefore, the artist is able to control the process by setting parameters such as the original sales price, the recycling-free period, and the recycling processing fee.

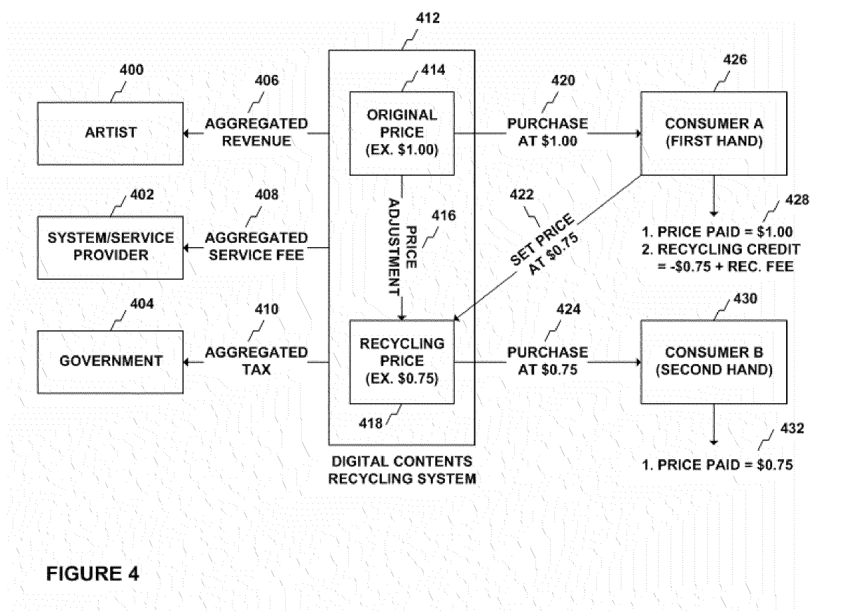

For an example, let's assume that an artist sets the sales price for his/her creation at $1.00 414 as illustrated in FIG. 4. The first consumer 426 who buy the content will pay $1.00 420. The revenue generated by this first purchase will be $1.00. Then the consumer is allowed to recycle the content after the recycling-free period, like 3 month. In other words, the consumer can not recycle the content during the recycling-free (hereinafter ReF) period. The ReF period prevents the consumer from recycling as soon as the purchase is made in order to protect the sales of original content. The artist should wisely choose the ReF period for their creation. After the ReF period has expired, the consumer is allowed to recycle the content at a price they choose. Let's assume the recycling price is set to $0.75 422 by the first-hand consumer. The posted recycling price will be $0.75 418. The second-hand consumer 430 now has two choices for same content from the original content or the recycled content. Since the recycled content is an identical duplicate of the original, the second-hand consumer will most likely pick the recycled content 424. As soon as the purchase is made, it will be removed from the System and another ReF period will apply to the content for the second-hand consumer. Now the sales credit 428 from recycling goes to the first-hand consumer 426 after a recycling processing fee is subtracted. Therefore sales credit will be less than $0.75. Overall, the final price that the first-hand consumer paid will be given by:

V(O)=1.00−0.75+REC.FEE=0.25+REC.FEE (where REC.FEE indicates the recycling processing fee).

When the recycling is completed, the first-hand consumer is allowed to choose to keep the content or to remove from his content list. The recycling processing fee will apply differently depending on the choice that the consumer made. During the recycling process, the System collects the first sales price and then the recycling processing fees.

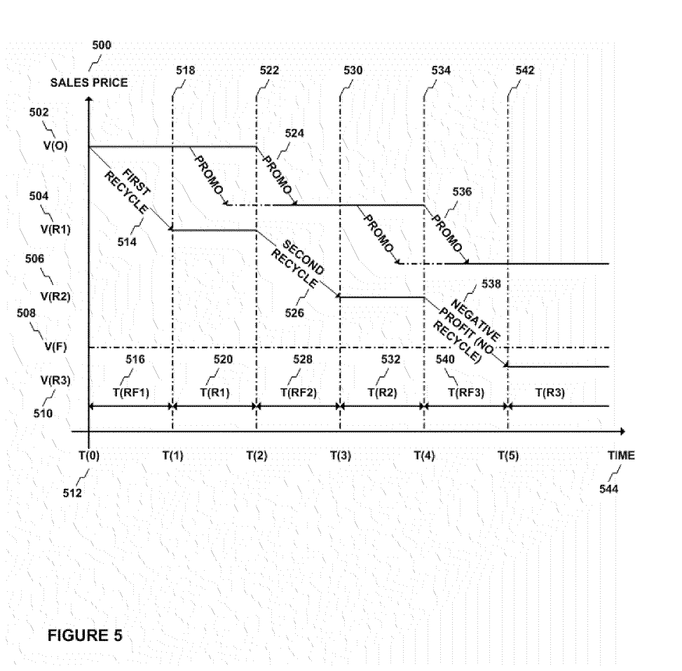

The recycling process can be regarded as the process that is able to determine the real value of digital content in the commercial market. If the consumers couldn't find any value in the digital content, then the rate of recycling will increase high and the recycling price will go down and it will determine the lifetime of digital content in the market. The System can collect those kinds of statistical data through the recycling process and the artists can decide the marketing strategy for their creations by manipulating the recycling parameters such as the sales price, the ReF period, and the recycling processing fee. The System is the marketing tool for the artist. FIG. 5 illustrates an exemplary graph of price change during the recycling process. When the first recycling is made after the first ReF period 516, there is a gap between the original price V(O) 502 and the first recycling price V(R1) 504. If the digital content is very popular, then the time duration that the recycling content remains on the list will be very short. As long as the pool of recycling content is empty at the moment, the sales on the original content will continue. If it is not the case, then the artist can lower the price of original content and/or offer any additional promotion items 524, 536 such as T-shirts, artistic booklets, etc. Since the recycling price has a tendency to go down at every recycling purchase, the content that cannot generate revenue more than the recycling processing fee 538 will be eventually removed from the System.

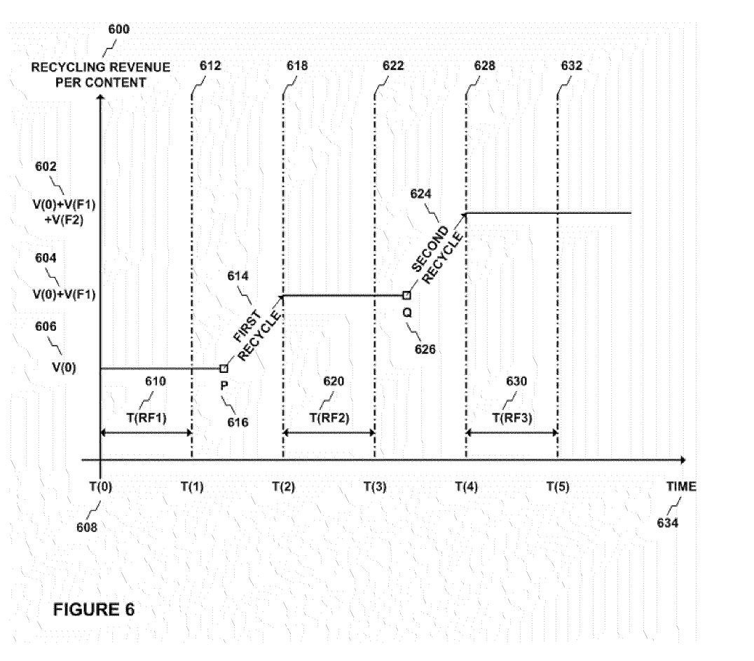

FIG. 6 illustrates the aggregated revenue graph of recycled content. The System can generate revenue from the first sales transaction of digital content 606 and then collect the recycling processing fees 614, 624. The consumer who recycles content is compensated with a credit which is transferred from the next-hand consumer. The consumer who purchases recycled content is offered at lower price than the previous one.

### 3. Artist Workstation

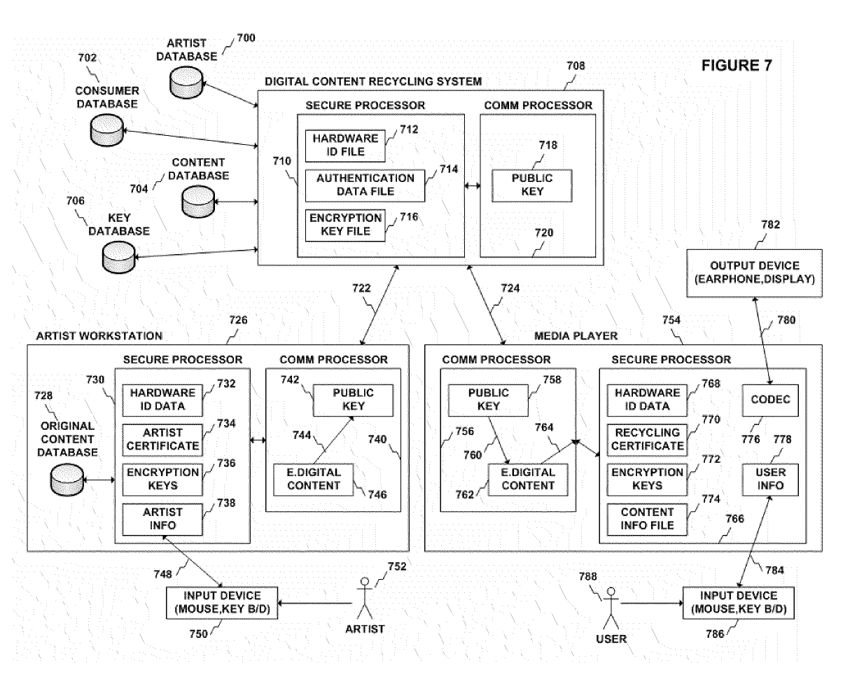

Even if the recycling process of digital content inherently encourages the consumers not to violate the copyright protection law, it would be not wise to distribute the digital content in any insecure raw form. In order to enforce the security of recycling process, the System uses secure data communication methods. The artist workstation indicates the platform that an artist uses when he/she creates their original digital contents. It could be a common computer or any customized machine. As illustrated in FIG. 7, the artist workstation 726 used with the System consists of a database system 728, a secure processor 730, and a communication processor 740. The secure processor can be any microprocessor which contains the internal memory blocks, the central processing unit for computations, and I/O peripherals to interact with outside. The internal memory blocks consist of non-rewritable and rewritable ROM. In the non-rewritable block of memory, the secure data such as hardware ID data 732, artist certificate 734, encryption keys 736 are stored. Those data were set at the factory and they are not changeable once written. The secure processor is able to read the content, but it is so made that the communication processor or any other I/O peripherals 750 can not access the memory that contains secure data. In the rewritable memory block of the secure processor, other data such as artist info are saved and they can be changed. Same as non-rewritable memory block, the secure processor is so made that the re-writable memory block can not be accessed from outside. When the artist 752 creates a digital content, the resultant content will be fed into the secure processor through input devices 750 such as external key board, mouse, or memory device. The secure processor provides I/O peripherals for the input devices. The secure processor encrypts the content with encryption key 736 and saves the result in the content database 728. Once the digital content was encrypted, the communication processor fetches the encrypted content 746 from the secure processor and transmits content 746 to the System through a secure network connection which uses a public encryption key 742.

### 4. Digital Content Recycling System (or the System)

The System consists of the communication processor 720, the secure processor 710, and the various database systems. The System can be implemented as a complicated server system and/or a specialized hardware platform which supports Web access. The communication and secure processors can be implemented as a background process of server or a dedicated special microprocessor. The communication processor of the System handles the network connection with artist workstation or media player. When encrypted digital content is received over secure network connection, the communication processor decrypts the incoming traffic with the public key 718 and decodes the encrypted digital content. The secure processor decodes the artist ID info, the hardware ID info, and the content info from the received encrypted digital content. By the artist ID info, the secure processor is able to retrieve the hardware ID info. By the hardware ID info, the secure process is able to retrieve encryption keys assigned to the artist's secure processor. For efficient data processing, the hardware info can be stored temporarily in Hardware ID File 712, the artist info in Authentication Data File 714, and the encryption keys in Encryption Key File 716. Artist database system 700 contains the data related to all the registered artists. The consumer database system 702 contains the data related to all the registered consumers. The content database system 704 contains the data related to the digital contents registered to the System by the artists. The key database system 706 contains all the encryption keys that stored in the secure processors of artist workstations and media players. When the digital content transmitted by the artist is stored in the content database, it can be encrypted or decrypted depending on the security policy of the System.

### 5. Media Player

Media player 754 consists of communication processor 756 and secure processor 766. The communication processor uses the public key 758 to decrypt the digital content that is being transmitted from the System. The received digital content is double encrypted by the public key and the encryption key of the secure processor. The digital content 762 still remains encrypted even after it was decrypted by the public key. Since the encryption keys stored in the secure processor memory block cannot be accessed, the digital content stored in the communication processor can be protected. The final decryption of digital content is done by the secure processor when the consumer plays the content. The decrypted digital content is directly converted by the codec 776 into an analog form that is presented only on the output devices 782 such as speaker, ear phone, or LCD display. When a new digital content is downloaded into the memory block of communication processor, it is fed into the secure processor in order to extract content info and update the content info file 774 stored in the re-writable memory block.

The internal memory blocks consist of non-rewritable and rewritable ROM. In the non-rewritable block of memory, the secure data such as hardware ID data 768, recycling certificate 770, encryption keys 772 are stored. Those data were set at the factory and they are not changeable once written. The secure processor is able to read the content, but it is so made that the communication processor or any other I/O peripherals 786 can not access the memory that contains secure data. In the rewritable memory block of the secure processor, other data such as user info is saved and it can be changed. As with the non-rewritable memory block, the secure processor is so made that the re-writable memory block cannot be accessed from outside. The consumer/user 788 is able to access to the content info file through input devices 786 such as external key board, mouse, or memory device. The secure processor provides I/O peripherals for the input devices.

The digital content that was created by the artist is protected by encryption keys stored in the secure processor. Once the digital content is encrypted, the encrypted content is double encrypted by the public key when transmitted between the System and artist workstation and between the System and media player. Every secure processor on the artist workstation and the media player has different set of encryption keys and they are set at the factory. In this way, the digital content that is playable on one media player can not be played on a different media player. It is therefore useless to copy the encrypted digital content into another media player.

### 6. Artist Registration and Activation

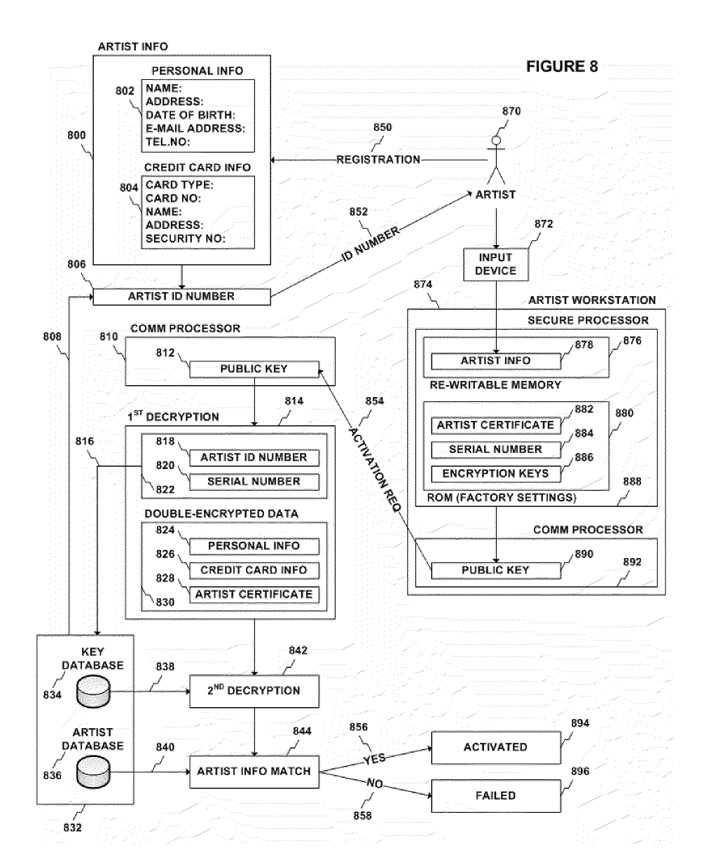

In order to submit digital contents, the artist should register his/her workstation to the System as illustrated in FIG. 8. Without registration, the System is unable to associate the artist with the secure processor in artist workstation. In order to register to the System, the artist is required to get an ID number from the System by registering online. The artist is directed to enter name, address, date-of-birth, e-mail address, telephone number, and credit card information. The System will allocate a unique ID number to the artist. Then the artist 870 enters ID number and other information 878 such as name, date of birth, address, etc. into the secure processor 888 through input device 872. Artist information is stored in the re-writable memory block 876. In the non-rewritable memory block, other information such as artist certificate 882, serial number 884, encryption keys 886 are stored. The System can identify artist certificate and encryption keys by the serial number assigned to the secure processor. When an activation request is issued by the artist, the secure processor encrypts the artist info, except ID number and artist certificate, by using the encryption key and appending the serial number and ID number to it. The serial number of secure processor and the ID number of artist are not encrypted. The resultant data is then encrypted by the communication processor 892 with the public key 890 before the transmission. When the System receives the activation request, the data packet is decrypted by the public key 812 and the secure processor decodes the artist ID number 818 and the serial number 820. The secure processor looks up the database system 832 by serial number and retrieves encryption keys and artist certificate 816. By using encryption key, the artist certificate and information transmitted by the artist workstation are decrypted to recover the original data. The secure processor retrieves artist information by the artist ID number and compares them to the decrypted information. If there is a match then artist certificates 828 are compared. When both decrypted information matches, the System is able to associate the artist ID number with the secure processor of artist workstation 894. If any of them does not match, the activation request is denied 896. When the artist workstation is activated, the artist is able to submit their creations to the System.

### 7. Submitting Digital Content

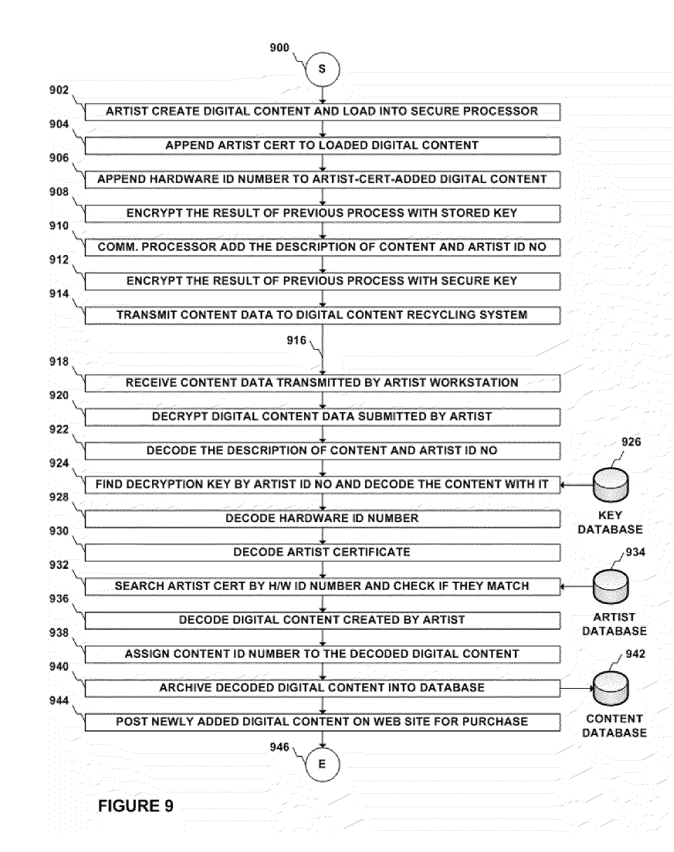

Once the artists have registered to the System and activated their workstations which have the capability of the secure and communication processors, they can submit their creations to the System by using secure network connection as illustrated in FIG. 9. First, the artist creates a music file, a video file, or a story book in a digital form and then loads the content into the secure processor 902 through input devices that are supported by I/O peripheral interfaces. Or the communication processor is able to do the same things if it has I/O peripheral interfaces available to the input devices such as USB port, RS232 serial port, keyboard, mouse, memory card slots, etc. The artist can also set general information for the data such as author, title, date/time created, description. When the content is loaded into the secure processor, the artist certificate stored in the memory of secure processor is appended 904. After the hardware ID number is added 906, the resultant data is encrypted with encryption key 908. The communication processor appends file information with the artist's ID number 910, encrypt it with the public key 912, and transmit to the System 914. When a creation is received by the System 918, the reverse process is taken place. The received digital content is decrypted by the public key 920 to decode the content information and the artist ID number 922. The decoded artist ID number is used to look up the encryption keys assigned to the artist's workstation. The digital content decoded by the communication is passed down to the secure processor and it is decrypted by the encryption key retrieved from the System's key database 924. When the decryption is performed successfully, then the hardware ID number 928, the artist certificate 930, and the original digital content 936 created by the artist will be decoded. If both the decoded and locally retrieved information such as hardware ID number and artist certificate matches, then the decoded digital content can be registered to the System. The decoded digital content is assigned a unique ID 938 and stored in the content database 940. The newly added content is posted to the Web site of the System 944.

### 8. Purchasing Digital Content

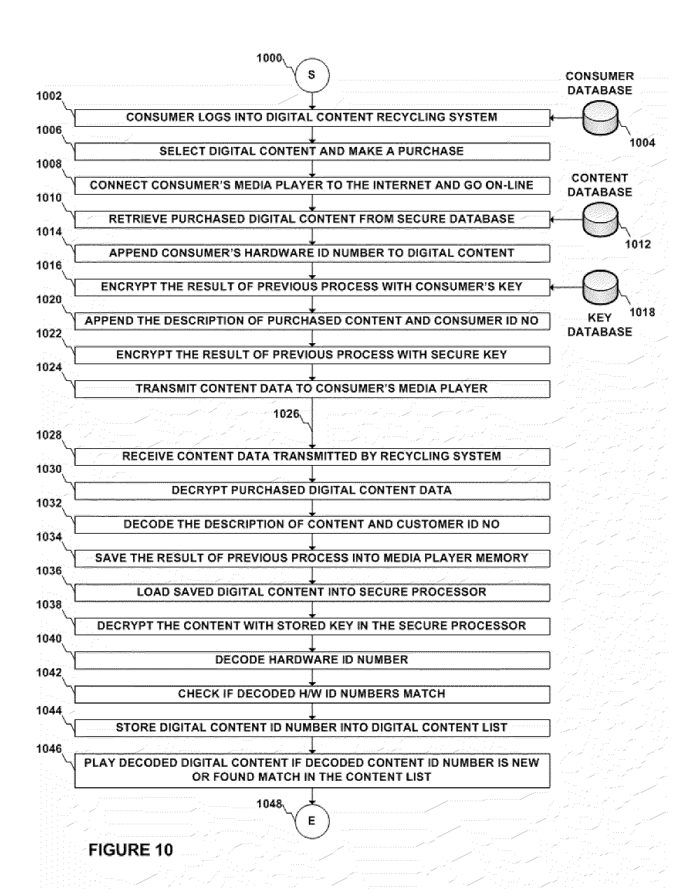

Once consumers have registered themselves to the System and activated their media player which has the capability of the secure and communication processor, they can log into the System Web site and make a purchase on the posted digital content which is either original or being recycled as illustrated in FIG. 10. The consumer logs in to the System by using ID number and/or password that was assigned during the registration process 1002. The consumer browses the System Web pages to view the digital content of interest and to make a purchase on the content that they decide to buy 1006. When necessary, credit card information can be used during the purchase process. The consumers prepare their media player and connect it to the Internet and bring it online During this process, the media player preferably sends out a connection request to the System. When a connection request is received, then the System preferably exchanges as many as necessary messages with the media player until it is identified. The authentication of the media player preferably is performed automatically without the intervention of the customer. Once the media player goes online 1008, then the customer can download the purchased content into their media player. When a download request is initiated, the secure processor of the System retrieves the selected digital content from the content database 1010. After the content is retrieved, the hardware ID number of the media player that is online and initiated the download request is added to the content 1014 and then the resultant content is encrypted with encryption key assigned to the secure processor of media player 1016. In order to enforce the security, the consumer certificate can also be added to the retrieved content before encryption. Both the content information and the consumer ID number are appended 1020, encrypted by the communication processor with the public key 1022, and transmitted to the media player 1024.

When the media player completes the downloading 1028, the communication processor of media player decrypts the received data with the public key 1030 and decodes the content description and the consumer ID number 1032. The result is saved in the memory of media player 1034. Since the digital content still remains encrypted, it is safe to store in the memory of communication processor or in an external detachable memory device. The communication processor preferably plays the content by transmitting the content to the secure processor 1036. When the secure processor of media player loads the content into the internal memory block, it is automatically decrypted with the encryption key stored in the non-rewritable memory 1038. In this process, the hardware ID number and/or the consumer certificate are decoded 1040. The secure processor checks if both the decoded and locally stored hardware ID numbers match 1042. If it is a match, then the secure processor looks up the content ID number with the content list stored in the rewritable memory. If there is no content record that matches found, then it is added to the content list. When the match fails, then the secure processor is preferably programmed to signal the communication processor to report the mismatch result back to the System. After the digital content is successfully authenticated by the secure processor, the original content can be decrypted with encryption key stored in the non-rewritable memory and the original form of creation can be reconstructed by the codec to produce analog audio, or video signals 1046.

### 9. Recycling Digital Content

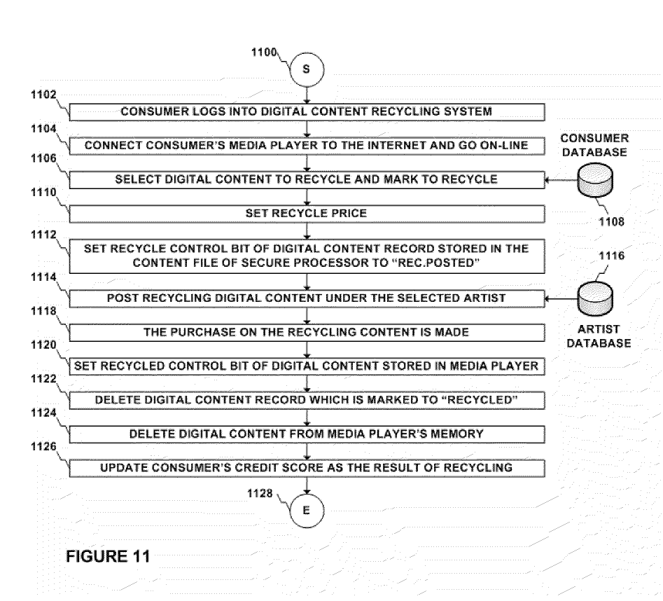

The consumer is entitled to recycle any digital content that they purchased from the System as illustrated in FIG. 11. The consumer logs into the System by using their ID number with password 1102 and connect their media player to the Internet and bring it online 1104. The consumer browses into their customized pages that shows the list of digital contents they purchased and select items to recycle 1106 and set the recycling price 1110. The System preferably helps the consumer to decide the recycling price properly by showing the recycling processing fee. This lets the consumer know if they are going to generate a credit from recycled items or not. The selected content is then marked with a flag “REC.POSTED” 1112, 1114 which indicates that the content is posted to the System for recycling. When a purchase is made on the posted item by another consumer, the control bit allocated to the recycled content is marked to “RECYCLED” 1122. Any status change on the content list will be reflected to the content list stored in the rewritable memory of secure processor of media player 1114, 1120. The secure processor should delete any content record that was marked to “RECYCLED” from the content list 1122. Finally, the credit score for the consumer is updated 1126.

### 10. Media Player Authentification

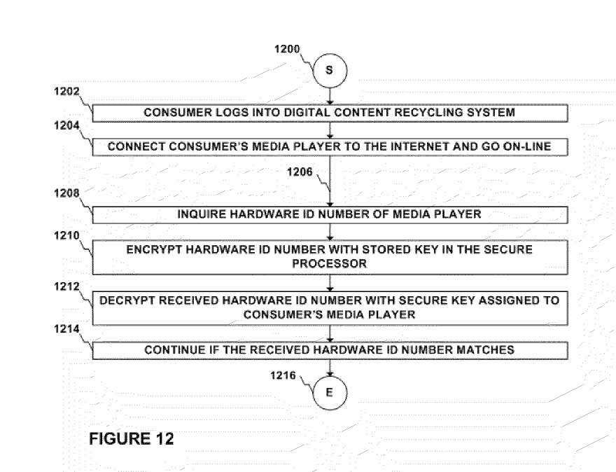

When a media player goes online, the System preferably decides to authenticate the remote media player by sending an authentication request as illustrated in FIG. 12. The consumer logs into the System with the consumer ID number 1202 and connects his media player to the Internet and brings it online 1204. The System initiates the authentication by sending out a request to inquire the hardware ID number of media player 1208. The communication processor relays this inquiry to the secure processor of media player. When the secure processor receives an authentication request, it encrypts the hardware ID number and sends out the result back to the System 1210. The communication processor encrypts the response message from the secure processor with the public key. The System extracts the response message and decrypts the hardware ID number 1212. The System uses the consumer ID number to look up the hardware ID number with the databases. If both the received and locally stored hardware ID numbers match, then the authentication is regarded as a success 1214.

### 11. Content List Synchronization

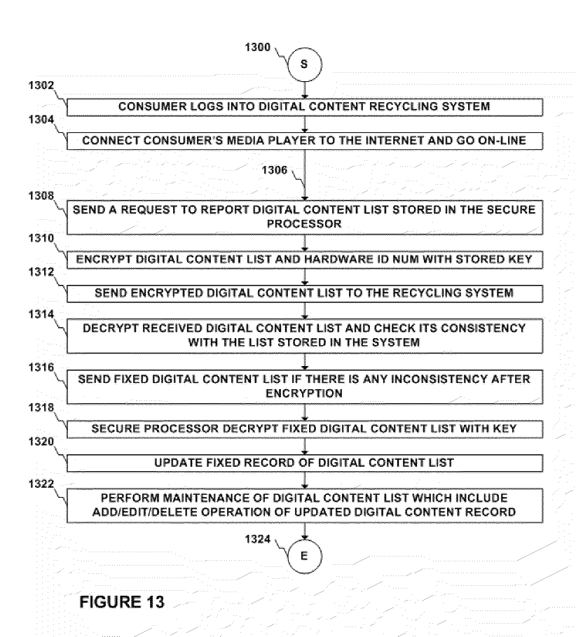

When a media player goes online, the System preferably decides to synchronize the content list of media player with the list stored in the System's databases as illustrated in FIG. 13. Content list synchronization is a security measure which monitors the current status of consumer's media player and detects any violation of misusage or any mismatch. Based on the computational outcome of content list synchronization, the System preferably initiates any security measure to block the use of media player by manipulating the control bits assigned to each digital content record. The consumer logs into the System with the consumer ID number 1302 and connects his media player to the Internet and brings it online 1304. The System initiates the synchronization of content list by sending out a request to inquire the content list of media player 1308. The communication processor relays this request to the secure processor of media player. When the secure processor receives a synchronization request, it encrypts the content records in the list with the hardware ID number 1310 and sends out the result back to the System 1312. The communication processor encrypts the response message from the secure processor with the public key. The System extracts the response message, decrypts the hardware ID number and the content records, and checks any inconsistency between the received and locally stored content records 1314. The System uses the consumer ID number to look up the hardware ID number with the databases. If both the received and locally stored content records do not match, then the fixed content records are computed and sent out to the media player 1316. When a fixed list of content records is received, the secure processor decodes the records 1318 and updates the content list with them 1320. The secure processor preferably initiates a maintenance task which reads the control bits of each content record and performs the predefined functions such content record deletion from the list, content deletion from memory, etc 1322.

### 12. Exemplarary Web Pages

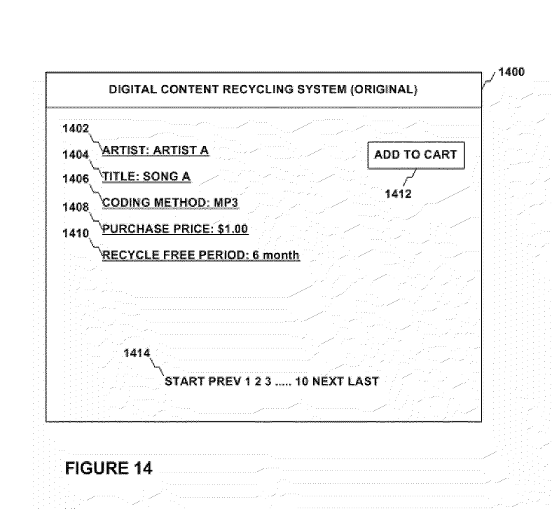

FIG. 14 illustrates an example of artist page which shows the information of digital content. The Web page 1400 contains the name of artist 1402, the title 1404, the coding method 1406 like MP3 as a audio file, the purchase price 1408 set by the artist, the ReF (recycling-free) time 1410, the date/time created, etc. The consumer preferably browses into this page by various methods such as selecting the artist, the genre from the list. The consumer clicks the add-to-cart button 1412 to purchase the item and there is a page change control on the bottom of page 1414.

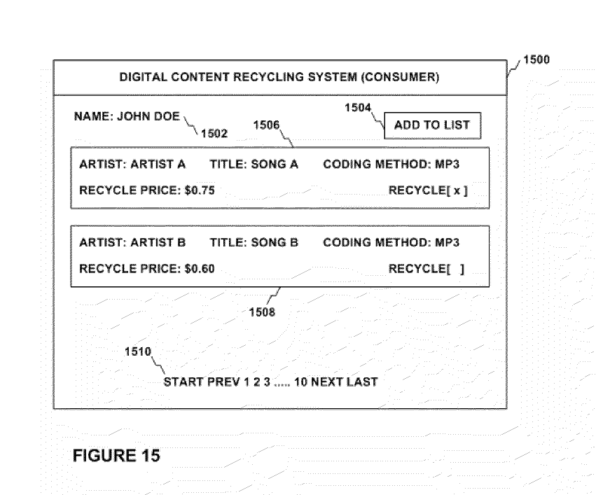

FIG. 15 illustrates an example of consumer page. The page 1500 contains the list of contents with some detailed information. Each item contains the name of artist, the title, the coding method. Each item also presents the recycle price which the consumer set and the check box to indicate that the selected item is being recycled. When the consumer clicks the add-to-list button 1504, the selected contents will be collected and submitted to the System for recycle.

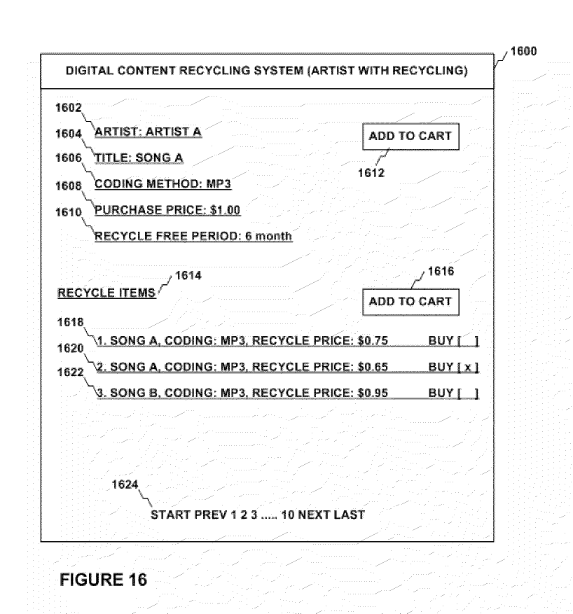

FIG. 16 illustrates another example of artist page which contains recycling items posted by other consumers. The recycle items 1614 show the list of recycling items and each item has a recycling price. Note that the same recycling item has been set to different prices. It is expected that the lowest price item will be sold first. The consumer clicks the add-to-cart button 1616 to make a purchase. Any recycled item is removed from the list after the transaction completed successfully.

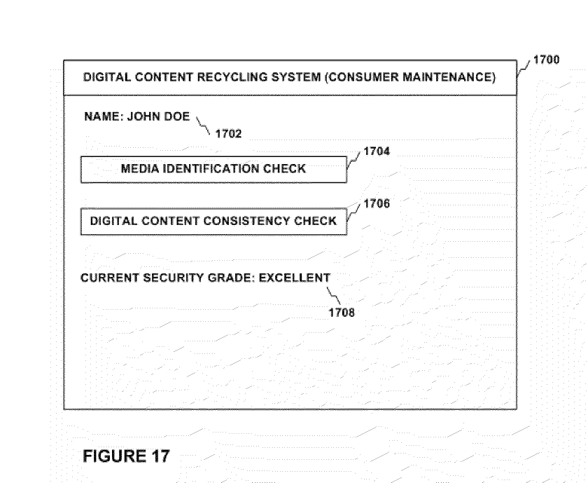

FIG. 17 illustrates an example of maintenance page. The maintenance page is used to check the security status and evaluate the current security grade. The media-identification-check button 1704 is used to perform the media player authentication and the digital content consistency check button 1706 is used to perform the content list synchronization. When the content list synchronization is performed, the number of inconsistent occurrences, i.e. the number of mismatches on content records will be counted and reported by the media player back to the System. Based on the results, the System grade the current security status. For example, the System categorize the security grade as “COMPROMIZED”, “POOR”, “MODERATE”, “GOOD”, and “EXCELLENT”. Based on the grade evaluation, the System preferably initiates a security measure to improve any violation of copyright protection.

### 13. Content List Management

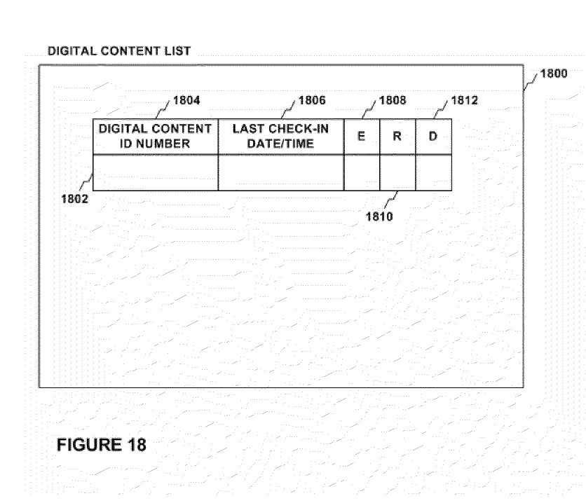

The content list is a set of content record as illustrated in FIG. 18. Each content record consists of the digital content ID number 1804, the last check-in date/time 1806, and various control bits. The digital content ID number indicates an identification number which is uniquely assigned to the given content when the artist submitted to the System. It is different than the file name assigned to the content. This number is transmitted to the media player when the consumer purchased the content. The last check-in (LCI in short) date/time indicates the latest date/time when the media player was connected to the Internet and authenticated by the System. The LCI date/time can be used to enhance the security measure. For example, when a media player is graded as less than “GOOD” and the LCI date/time passes a due date which was set by the System, then the secure processor of media player preferably is set to disable and/or delete the said content from the content list and/or the memory of communication processor. The control bit “E” 1808 is defined to enable/disable the content. The control bit “R” 1810 is defined to indicate that the said content is now on the recycling roaster. The control bit “D” 1812 is defined to indicate that the said content should be removed from the list.

### 14. Data Mining

The artists can use the System as a marketing and distribution tool for their creations. The consumers can use the System as a legal way to get their favorite digital contents at an optimal price. Actually, it is impossible to set an optimal price without the knowledge of consumer's demand which is being revealed in the real market. Nobody knows which price is the real price for the said digital content with the traditional distribution systems. The System presented in the current invention provides a practical way to achieve this goal. Even if the original sales price set by the artist is higher that the optimal price in the market, the recycling process compensates the first-hand consumer with the credit which is generated from the next purchase. As long as there is demand on the said content, the recycling price will have a tendency to remain close to the original sales price. Since the amount of recycling stops within limited cycles, eventually the said recycled content is removed from the recycling roster. Therefore, there are always chances for the original content to be purchased by other first-hand consumers. If the demand on the said content is very low, then the recycling price will be set at a much lower figure. A large gap between the original price and recycling prices will drive the artist to adjust their sales price. As the recycling processes continue, the original sales price will approach toward its optimal price that is determined in the market based on a demand-supply basis. The System provides the artists with a tool to control the progress of recycling processes. The artists can use several parameters such as the original sales price, the ReF (recycling-free) period, and the recycling process fee. It is also possible for the artists to adjust their original sales price at any time based on the status of recycling process. The recycling process can be statistically characterized by defining several parameters such as the price of first recycling, the time period that the first recycling content remained in the roaster, the price of second recycling, the time period that the first recycling content remained in the roaster, etc. Through data mining, the System can characterize the artists, the digital contents, the consumers, and the recycling processes and a marketing strategy can be rendered for the artists. The primary advantage of the current invention is that the copyrights of artists can be protected not by overusing technologies to detect any tampering to original contents, but by encouraging the consumers under the consents of artists with recycling-generated credits to comply the law proactively.

### 15. Deterrent to Copyright Infringement

Preferred embodiments of the present invention focus on artists who create digital contents, the secure media players that the consumers use to purchase and play digital contents and the secure transaction system that accepts digital contents from the artists and distributes them to the end consumers. The artists with the digital content recycling system are the original providers who create various type of digital content such as mp3 audio, mpeg video, electronically readable book, etc. The present invention includes digital players which are capable of converting mp3 data file into audio signals and which are capable of converting electronic book data into electric signals so that a display device such as LCD panel can represent them in a readable text on the screen. The primary role of the present invention is to securely deliver digital content from the artists to the end consumers. As seen in the prior art, when digital content is created by the creator and released in an electronic form like a computer file, it is inevitably pirated illegally by people with the help of recent technologies. Tremendous efforts have been made to protect the artists from copyright infringement, but many methodologies require special types of digital players in order to play the content correctly and this in turn is a sacrifice to consumer friendliness. The present invention presents a new type of copyright protection method with digital content recycling system. First, in preferred embodiments, all digital content will be encrypted with keys stored in the secure processor of the consumer's media player and every media player has a different set of encryption keys. For example, even the same digital content which is playable on a media player can not be played with a different media player. Secondly, every consumer who is subscribed to digital content recycling system is allowed to sell the digital contents for their own profits under certain restrictions with the consent legally granted from the artists. The artists give the consumers the consent to recycle their digital content and it gives a legal protection to the consumers. Digital content is said to be recycled when the digital content was purchased from any seller or recycler who is someone other than the original artist. Moreover, even after recycling, preferably the consumers are granted to keep their digital contents. In order to compensate the power given to the consumers, the system provides the artist with the capability to manage the whole recycling process in such a way that they can set the original sales price, adjust the recycling-free time period during which the consumers will be unable to recycle, and charge a recycling fee which is applicable when recycling is for the digital content. A recycling of digital content itself is not the primary factor that contributes to the copyright protection. It is the change of consumer's attitude that prohibits any illegal distribution of digital content. As long as they are legally allowed under the artist's consent to recycle their purchased contents and keep them after recycling, they will not commit any copyright violation which possibly undermines the recycling price that they are going to set later. There will be a tendency in setting the recycling price, which is slightly lower than the original purchasing price. This will drive the recycling price down at every recycling moment, but this price down tendency must eventually stop when the recycling price becomes lower than the recycling process fee set by the system. In other words, when the customer is unable to make a recovery, the recycling cycle ends. By setting the recycling-free time period and the recycling process fee wisely, the artist can control the number of recycle per digital content without hurting the consumer's loyalty.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention

What is claimed is:

1. A computer network for the purpose of distributing artistically created digital content, said computer network comprising:
A. at least one artist workstation computer programmed to receive from an artist said artistically created digital content,
B. a digital content recycling system computer connected to said at least one artist workstation computer via said computer network, said digital content recycling system computer for receiving said artistically created digital content from said at least one artist workstation computer and for offering said artistically created digital content for sale at an initial sales price,
C. at least one first consumer computer connected to said digital content recycling system computer via said computer network, said at least one first consumer computer for purchasing said artistically created digital content at said initial sales price, and for transmitting a recycling price for said artistically created digital content to said digital content recycling system computer, and
D. at least one secondary consumer computer connected to said digital content recycling system computer via said computer network, said at least one secondary consumer computer for purchasing said artistically created digital content at either said initial sales price or at said recycling price.

2. The computer network as in claim 1, wherein said at least one artist workstation computer is programmed to encrypt said artistically created digital content prior to transmitting said artistically created digital content to said digital content recycling system computer to protect against piracy.

3. The computer network as in claim 2, wherein said digital content recycling system computer, said at least one first consumer computer and said at least one secondary consumer computer each are programmed to encrypt and decrypt said artistically created digital content to protect against piracy.

4. The computer network as in claim 1, wherein said initial sales price is set by the artist at said at least one artist workstation computer.

5. The computer network as in claim 1, wherein said recycling price is set by said first consumer at said at least one first consumer computer.

6. The computer network as in claim 1, wherein said at least one secondary consumer computer is a plurality of secondary consumer computers.

7. The computer network as in claim 1, wherein said artistically created digital content is recycled multiple times at progressively lower recycling prices.

8. The computer network as in claim 1, wherein said digital content recycling system computer is programmed to charge said recycling price and a recycling fee to a secondary consumer at said at least one secondary consumer computer.

9. The computer network as in claim 1, wherein an artist at said at least one artist workstation computer transmits a predetermined recycle free period before recycling of said artistically created digital content can begin.

10. The computer network as in claim 1, wherein said artistically created digital content is music.

11. The computer network as in claim 1, wherein said artistically created digital content is a video.

12. The computer network as in claim 1, wherein said artistically created digital content are images.

13. The computer network as in claim 1, wherein said artistically created digital content is an electronically readable book.

14. The computer network as in claim 1, wherein said computer network is the Internet.
